(19) United States
(12) Patent Application Publication
(10) Pub. No.: US 2020/0034819 A1
(43) Pub. Date: Jan. 30, 2020

(54) SYSTEM AND METHOD FOR AN ON DEMAND KIOSK

(71) Applicant: Toshiba America Business Solutions, Inc., Lake Forest, CA (US)

(72) Inventors: William MELO, Lake Forest, CA (US); Lee Michael SULLIVAN, Lake Forest, CA (US); Ryan BATTAGLIA, Lake Forest, CA (US); Candice HAGA, Lake Forest, CA (US); Timothy SANDBERG, Lake Forest, CA (US)

(21) Appl. No.: 16/594,757

(22) Filed: Oct. 7, 2019

Related U.S. Application Data
(63) Continuation of application No. 14/937,461, filed on Nov. 10, 2015.
(60) Provisional application No. 62/077,696, filed on Nov. 10, 2014.

(51) Int. Cl. G06Q 20/32; G06Q 20/12; G06Q 20/18; H04W 4/80

(52) U.S. Cl. CPC G06Q 20/3224; G06Q 20/123; H04W 88/02; G06Q 20/3278; H04W 4/80; G06Q 20/18

(57) ABSTRACT

A method and system for transferring media on demand to a mobile computing device of a consumer is presented. A sensor in a kiosk identifies a consumer by facial recognition algorithms or identification of the mobile computing device of the consumer. An interactive display presents media that is available for download by the consumer based at least in part on the identity of the consumer. The consumer touches their mobile computing device to a short range communications interface on the kiosk which transfers the media to the mobile computing device. The media can be streamed to the kiosk from a remote content server across a network. The kiosk can process the consumer payment for the downloaded media by sending payment transactions to a payment network.

### REFERENCE TO RELATED APPLICATION

The present application is a Continuation of U.S. Non-Provisional application Ser. No. 14/937,461, filed Nov. 10, 2015, which claims the benefit of U.S. Provisional Application Ser. No. 62/077,696, filed Nov. 10, 2014, and hereby incorporates the same herein by reference in its entirety.

### TECHNICAL FIELD

The subject application teaches example embodiments that relate generally to media kiosks for transferring media with portable user devices, and specifically to media kiosks having touch and get media transfer technology for transferring video and audio to mobile computing devices on demand.

### BACKGROUND

Kiosks can provide a convenient way for consumers and users to obtain a service or product without having to wait for assistance from a human attendant. Consumers routinely use kiosks to check in at airports to obtain airline tickets, view coupons and other discounts at supermarkets, and purchase products such as food, beverages, and small electronics.

Wireless communications protocols, including radio-based and induction-based wireless communication protocols enable high speed networking between devices. Some radio-based wireless protocols such as BlueTooth™ enable networking over short distances. Induction-based wireless protocols such as TransferJet™ enable high speed networking over very short distances, and are sometimes referred to as “touch” protocols because devices generally must be brought within touching distance to communicate.

### SUMMARY

In an example embodiment, a system includes a kiosk, a sensor displaced in the kiosk, an interactive display displaced in the kiosk, and a short range communication interface. The sensor is configured to identify a consumer. The interactive display is configured to display media that is available for download by the consumer based at least partially on the identity of the consumer. The short range communication interface is configured to transfer the media on demand to the consumer's portable data device. The system can include an embedded controller. The embedded controller can include a processor, a memory and a network interface. The memory and network interface are in data communication with the processor. The memory is operable for storage of data and instructions. The network interface is configured for data communications with a communications network. The embedded controller is configured to determine the identity of the consumer based at least in part on the data from the sensor. The embedded controller is also configured to determine a subset of media from a library of media to display to the consumer on the interactive display. The embedded controller is also configured to receive a selection from the subset of media displayed on the interactive display and transfer the selection of media to the portable data device of the consumer. The portable data device can be a smart phone, a tablet, a cell phone, a laptop, a personal computing device, and a media player. In a configuration, the sensor is a camera and the identity of the consumer is determined at least in part from a captured image. The captured image can include one or more portions of the consumer's face and the identity of the consumer is determined at least in part using facial recognition. The captured image can include a code that is displayed on the portable data device of the consumer and the consumer can be authenticated using the code. In a configuration, the sensor is an audio capture device and the identity of the consumer is determined at least in part using voice identification of captured audio. The sensor can communicate with the consumer's portable storage device to authenticate the consumer. The interactive display can be a touch screen and the consumer can select media to transfer to their portable data device by touching icons that are associated with one or more media selections displayed on the interactive display. The short range communication interface can be a TransferJet™ communication interface, a near field communication device, a Bluetooth™ interface, and an optical interface. The media can be a movie, a video, a song, an MP3 encoded song, an audio stream, a podcast, written content, a picture, or executable software and can include digital rights management technology. The embedded controller can retrieve selected media from a remote content server over a network. The embedded controller can received consumer payment data associated with the consumer and process a payment for the selected media with a financial institution or payment processor.

In an example embodiment, a method includes identifying a consumer who is in proximity to a kiosk by a sensor that is displaced in the kiosk. The method includes displaying media available for download by the consumer based at least in part on the identity of the consumer. The media is displayed by a display displaced in the kiosk. The media includes receiving a selection of media for download. The selection is received from the consumer. The method includes transferring the selection of media to the portable data device of the consumer. The method can include capturing one or more images of the consumer, when the sensor is an image capture device, and determining the identity of the consumer from one or more images of the consumer using facial recognition. The method can include retrieving the selection of media from a remote content server over a network. The method can include processing a payment across a network for the selection of media with a financial network or a payment processor.

In an example embodiment, an on demand media kiosk includes a display, a sensor, an embedded controller, and a short range communications device. The display is configured to display media available to download by a consumer. The sensor is configured to capture data associated with the consumer or the consumer's portable data device. The embedded controller is configured to authenticate the consumer from data from the sensor, determine a selection of media to be downloaded to the consumer's portable data device based on consumer interactions with the kiosk, process a payment from the consumer for the selection of media, and initiate a transfer of the selection of media to the consumer's portable data device. The short range communication interface is configured to transfer the selection of media to the consumer's portable data device when the portable data device is position in close proximity to the kiosk. The display can be a touch sensitive screen and the selection of media can be determined from the manipulation of icons by the consume using the touch sensitive screen. Each icon can be associated with one or more media items such as a movie, a video, a song, an MP3 encoded song, an audio stream, a podcast, written content, a picture, and executable software. The sensor can be an audio capture device, an image capture device, a video capture device, a near field communication interface, and a network communication interface. The short range communication interface can be a TransferJet™ communication interface, a Bluetooth™ interface, or an optical interface.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a block diagram of an on demand media kiosk.

FIG. 2 is a block diagram of components of an on demand media kiosk.

FIG. 3 is a flow diagram of example processes for an on demand media kiosk.

### DETAILED DESCRIPTION

Various non-limiting embodiments of the present disclosure will now be described to provide an overall understanding of the principles of the structure, function, and use of systems, apparatuses, devices, and methods disclosed herein. One or more examples of these non-limiting embodiments are illustrated in the selected examples disclosed and described in detail with reference made to the figures in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated by those of ordinary skill in the art that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack.

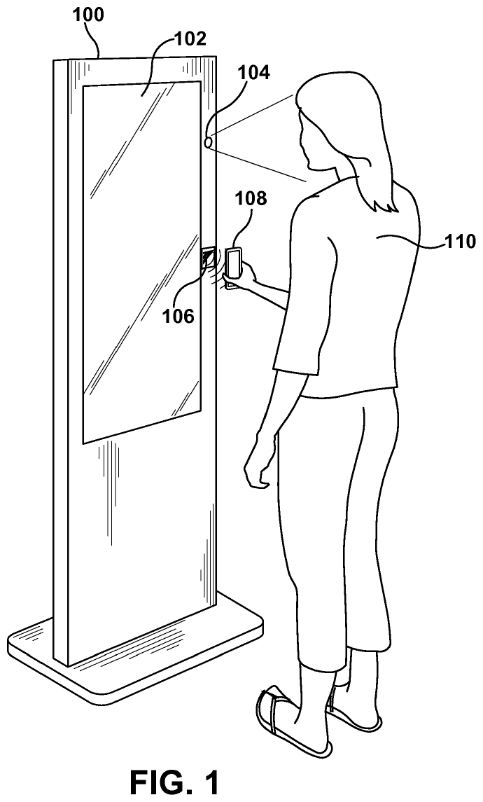

Referring now to FIG. 1, a block diagram of an on demand media kiosk 100 is presented. The on demand media kiosk 100 includes a visual display 102, a sensor 104, and a short range communication interface 106. A consumer 110 interacts with the on demand media kiosk 100 to select content to download onto the consumer 110 portable data device 108, for example by manipulating icons of a user interface displayed on the visual display 102. The portable data device 108 is positioned within range of the short range communication interface 106 and the desired content is transferred to the portable data device 108.

In a configuration, the consumer 110 places the portable data device 108 within range by touching the portable data device 108 to a designated area of the on demand media kiosk 100. For example, the on demand media kiosk 100 can include an area that is labeled with a graphic and/or words and that is proximity to the short range communication interface 106. When the consumer 110 places the portable data device 108 in contact with the labeled area, the portable data device 108 is within range of the short range communication interface 106. The short range communication interface 106 can be configured to be behind or beneath a portion of the on demand media kiosk 100 so as to protect antennas and other components of the short range communication interface 106.

The kiosk 100 can be configured to activate upon detection of the portable data device 108, for example when the consumer 110 touches the portable data device 108 to the kiosk 100. The kiosk 100 also can activate when the consumer 110 interacts with the kiosk 100, for example by touching the kiosk 100 or visual display 102. In an embodiment, the visual display 102 can be a touch screen which permits the consumer 110 to interact with the visual display 102 through touch.

The kiosk 100 can determine the identity of the consumer 110 using various different methods or combinations of methods. The consumer 110 can enter user information such as a username and password at the kiosk, or the identity of the consumer 110 can be determined by the kiosk 100. For example, the identity of the consumer 110 can be determined from the portable data device 108 of the consumer 110. For example data transferred between the kiosk and the portable data device 108 using near field communications can include consumer information. The kiosk 100 also can correlate data obtained from the portable data device 108 with the consumer 110, for example by examining data packets and searching for historical uses of that, or another kiosk, by the portable data device 108. In another example, a sensor 104 mounted in the kiosk 100 such as a camera can capture images of the consumer 110 and use image processing and facial recognition algorithms to identity the consumer 110.

Based on the identity of the consumer 110, the kiosk 100 can customize the display of various items of content or media that can be downloaded by the consumer 110. For example, based on the identity of the consumer 110, the kiosk can customize the display of media based on consumer preferences, age-related restrictions, saved play lists and queues, and other information as would be understood in the art. The content can be personalized, for example by grouping similar items by user preferences, genre, and type, as well as by heuristics and algorithms. Content can be personalized and can include promotional content, free content, and paid content.

The visual display 102 of the kiosk 100 can be a touch screen, permitting the consumer 110 to directly interact with elements on the visual display 102. For example, the consumer 110 can touch and select menu screens and icons to find desired content for downloading on the portable data device 108 of the consumer 110. Each icon can represent various types of content or media that the consumer 110 can download to the portable data device 108 such as a movie, a video, a song, an MP3 encoded song, an audio stream, a podcast, written content, a picture, and executable software. An icon also can represent a grouping of media, such multiple related chapters of a podcasts, multiple songs of an album, multiple chapters of a book, and so forth.

The consumer 110 can select the desired media to be downloaded to the portable data device 108. The consumer can pay for content using tokens, redemption codes, vouchers, coupons, credit or debit cards, bank transfers, and third party payment providers such as PayPal™ among other suitable payment options. The kiosk 100 can accept payment from the consumer 110 and transfer the selected media to a portable data device 108. Transfer of the purchased media can be accomplished via the short range communication interface 106 using a high speed protocol such as TransferJet™ or any other suitable protocol. Content and media that is protected as intellectual property can be transferred using any suitable digital rights management system or algorithm as would be understood in the art.

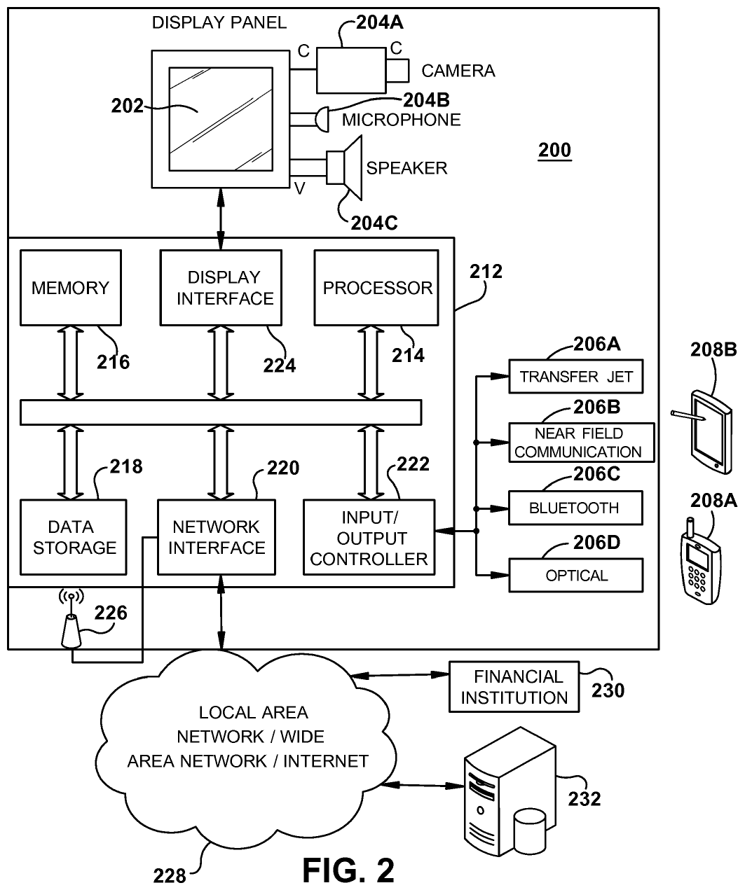

Referring now also to FIG. 2, a block diagram of example components of an on demand media kiosk 200 is presented. The on demand media kiosk 200 includes one or more computing devices 212. The computing device 212 can be any suitable computing device as would be understood in the art, including without limitation, a custom chip, an embedded processing device such as an embedded controller, a tablet computing device, a personal data assistant (PDA), a personal computing device, a desktop, a laptop, a microcomputer, a minicomputer, a server, a mainframe, or any other suitable programmable device. In some embodiments the computing device 212 can utilize cloud-based computing capabilities. In various embodiments disclosed herein, a single component can be replaced by multiple components and multiple components can be replaced by a single component to perform a given function or functions. Except where such substitution would not be operative, such substitution is within the intended scope of the embodiments.

The computing device 212 includes a processor 214 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 212 also includes one or more memories 216, for example read only memory (ROM), random access memory (RAM), cache memory associated with the processor 214, or other memories such as dynamic RAM (DRAM), static ram (SRAM), programmable ROM (PROM), electrically erasable PROM (EEPROM), flash memory, a removable memory card or disk, a solid state drive, and so forth. The processor 214 and memory 216 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

The computing device 212 also includes storage media 218. The storage media 218 can store copies of the content or media items that are available for download by the consumer. The storage media 218 can be a storage device that has multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media 218 also include flash drives, solid state hard drives, redundant array of individual disks (RAID), virtual drives, networked drives and other memory means including memories on the processor 214 or memories 216. It can be appreciated that such storage media 218 can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 220 can be configured to transmit to, or receive data from, other computing devices 230, 232 across a network 228, such as remote content servers 232 and financial institutions 230 which by that term is meant to include payment processors or acquirer processors as is understood in the art. The network and communication interfaces 220 can be an Ethernet interface, a radio interface 226, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 220 can include wired data transmission links such as Ethernet and TCP/IP. The communication interfaces 220 can include wireless protocols for interfacing with private or public networks 228. For example, the network and communication interfaces 220 and protocols can include interfaces for communicating with private wireless networks such as a WiFi network, one of the IEEE 802.11x family of networks, or another suitable wireless network. The network and communication interfaces 220 can include radio interfaces 226 and protocols for communicating with public wireless networks, using for example wireless protocols used by cellular network providers, including Code Division Multiple Access (CDMA) and Global System for Mobile Communications (GSM). A computing device 212 can use network and communication interfaces 220 to communicate with hardware modules such as a database or data store, or one or more servers or other networked computing resources. Data can be encrypted or protected from unauthorized access.

In various configurations, the computing device 212 can include a system bus for interconnecting the various components of the computing device 212, or the computing device 212 can be integrated into one or more chips such as programmable logic device or application specific integrated circuit (ASIC). The system bus can include a memory controller, a local bus, and/or a peripheral bus in communication with interface cards for supporting various input and output devices 202, 204, 206, 210. Example input and output devices can include one or more displays 202, a camera 204A and microphone 204B (collectively video input 204), and a speaker 210 or audio output device. In a configuration, the display 202, video input 204, and speaker 210 can interface with the computing device through a display interface card 224 as illustrated as would be understood by one of ordinary skill in the art.

Other example input and output devices can include a TransferJet™ interface 206A, a near field communications interface 206B (NFC 206B), a BlueTooth™ interface 206C, and/or an optical interface 206D (collectively short range communication interfaces 206). An example optical interface 206D can include, but is not limited to, an infrared transceiver. The short range communication interfaces 206 can be configured to transfer media to, or from, a user's smartphone 208A or tablet 208B (collectively portable data devices 208 or portable data devices). In a configuration, the short range communication interfaces 206 can interface with the computing device 212 through an input/output controller such as a Universal Asynchronous Receiver Transmitter (UART) or Universal Synchronous/Asynchronous Receiver Transmitter (USART) as would be understood in the art. Other input and output devices can include touchscreen interfaces, gesture or graphical input devices, keyboards, keypads, motion input devices, voice recognition units, vibratory devices, computer mice, and any other suitable user interfaces.

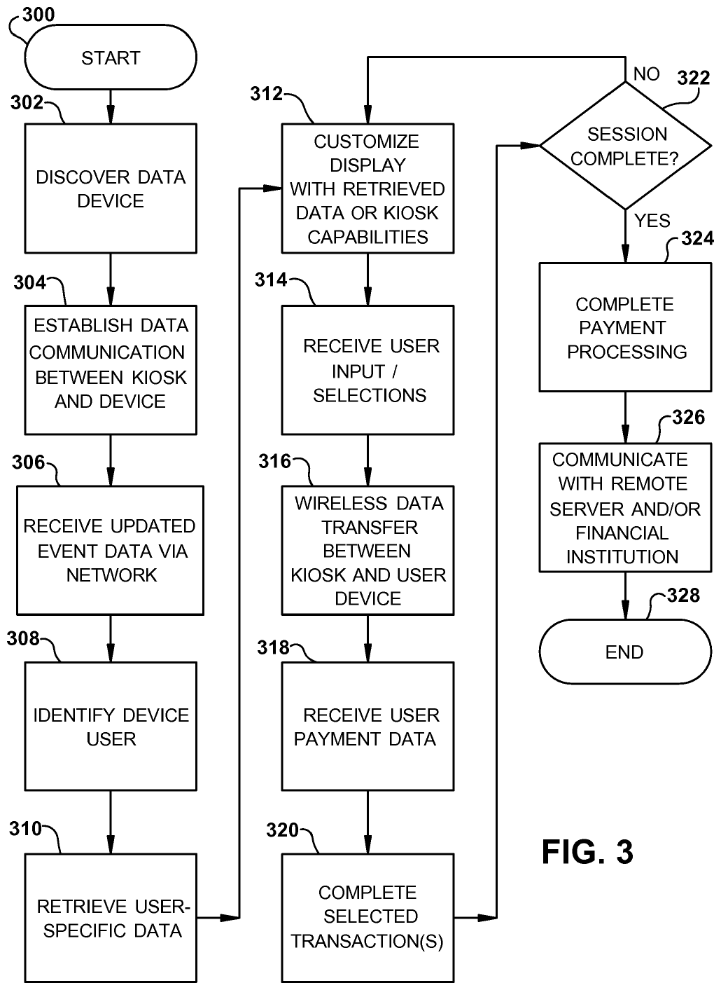

Referring also to FIG. 3, a flow diagram of example processes of an on demand media kiosk is presented. Processing begins at start block 300 and continues to process block 302.

At process block 302, the kiosk discovers the consumer's data device which can be, for example, a mobile computing device such as a smartphone or tablet. In an embodiment, the kiosk discovers the data device when the consumer brings the data device within range of a short range communication interface embedded int the kiosk. For example, the kiosk can detect a consumer's smart phone when the consumer touches their smart phone against a designated spot on the kiosk, such as the location of a TransferJet™ interface. In an embodiment where the short range communication interface is a TransferJet™ interface, the TransferJet™ interface will periodically transmit a request message; when a data device comes with range and receives the request message, the data device will respond to the request message with a response message and handshaking will be performed as described in process block 304. Processing continues to process block 304.

At process block 304, the short range communication interface can establish a communication link between the kiosk and the consumer data device. In the embodiment where the short range communication interface is a TransferJet™ interface, the data device will respond to a request message with a response message and handshaking will be performed between the TransferJet™ interface and the data device as is understood in the art. Processing continues to process block 306.

At process block 306, the kiosk can optionally receive updated event data over the network, for example from a remote content server. Updated event data can include notification of recent or new releases, such as new movies, songs, books, applications, or other content and media. In an embodiment, the kiosk can receive updated event data in response to establishing a link with a consumer data device. In this manner, the event data is refreshed when the consumer initially begins to use the kiosk. In embodiments, the kiosk can query for updated event data periodically, or updated event data can be pushed to the kiosk as updates become available. Processing continues to process block 308.

At process block 308, the kiosk can identify the consumer. In one embodiment, the consumer can be identified by information provided by the consumer data device. For example, data devices typically have a unique address, such as the data link layer address, that can be used to uniquely identify a particular data device. The kiosk can search through historical usage data to identify the consumer from previous uses of the same data device. In another example, the data device can provide identifying data during handshaking with the kiosk or from a separate near field communication session. In another embodiment, the kiosk can receive identifying data from the consumer. For example, a user can provide a username and password to the kiosk by entering it into appropriate fields in the user interface. In another embodiment, the user can be identified from a credit card or government issued identification, for example through captured images or entry by sliding a card into a magnetic strip reader or chip card reader. In yet another embodiment, the kiosk can identify the consumer using one or more sensors. For example, a camera sensor can capture one or more frames of image data, and process the image data using facial recognition algorithms to identify the consumer. In a related example, the consumer can display a code on the display of the consumer's smart phone, for example a bar code or QR (quick response) code; such as code may be displayed from a related mobile app that is executing on the smart phone. In another example, the sensor can be an audio capture sensor such as a microphone, and the consumer is identified by voice recognition algorithms. Processing continues to decision block 310.

At process block 310, the kiosk can retrieve consumer specific information. Consumer specific information can include preferences, age-related restrictions, play lists or queues, and other information as would be understood in the art. The consumer specific information can be shared by kiosks or retrieved from a data store, for example a cloud service associated with the kiosks. Processing continues to process block 312.

At process block 312, the kiosk can display media that is available for download from the kiosk. The available media can be customized based upon the consumer specific information. For example, if the consumer is under the age of 18, then only age-appropriate media may be presented for download. In another example, if the consumer has previously set up a queue of movies that the consumer desires to see, then the media items that are displayed can prioritize media items from the consumer's queue. Similarly, if new items of content or media have recently been made available, then the kiosk can prioritize those items for display to the consumer. Also, the media items that are displayed can be dependent upon the capabilities of the kiosk. For example, if a particular media item is located in a remote content server, and the Internet connection of the kiosk is slow or not functioning, then the kiosk can optionally not display that media item, or optionally display the media item along with additional information about the limited availability of that particular media item. Processing continues to process block 314.

At process block 314, the kiosk receives user input and selections. For example, the kiosk can receive a selection of a particular media item for download by the consumer. The kiosk can receive user input via any suitable means, including but not limited to manipulations of icons on the display screen by the consumer when the display screen is a touch screen. Each icon can represent a particular media items or groups of media items (for example, multiple chapters of a podcast or multiple songs of an album). The kiosk can receive a consumer input, such as a checkout command, that triggers the kiosk to begin downloading the media items to the consumer data device. Processing continues to process block 316.

At process block 316, the kiosk initiates the transfer of media items to the consumer data device, for example using TransferJet™ or another suitable high speed wireless networking protocol. Processing continues to process block 318.

At process block 318, the kiosk optionally receives consumer payment data. In various embodiments, the consumer payment data can be retrieved from a user profile, or consumer payment data can be entered at the kiosk by the consumer. For example a consumer can present a payment card to a camera input of the kiosk that can use optical character recognition algorithms to determine the card information. Similarly, a card processing input such as a magnetic strip reader or card chip reader can be used, if available on the kiosk. In a configuration, card payment information can be tokenized as would be understood in the art. In another example, payment information data can be entered using a coupon code or voucher. In another example, payment information can be entered using third party payment providers such as PayPal™. Processing continues to decision block 320.

At process block 320, the kiosk completes the transactions of process blocks 316 and 318. For example, if the payment is being made using a credit card, the kiosk can request a credit card authorization hold from the payment network for the amount of the media items. The payment network can include a credit card processor that handles the credit card payment transaction and/or the financial institution that issued the credit card. In a configuration, the kiosk can transmit media items or portions of media items concurrent with, or in advance of, completing payment. In this manner, the amount of time that the consumer waits at the kiosk for media downloads can be reduced. Processing continues to decision block 322.

At decision block 322, if the consumer ends the session at the kiosk, then processing continues to process block 324. For example, the consumer can select a checkout feature from the display of the kiosk, and processing continues to process block 324. In another example, if the consumer moves their data device away from the kiosk, the session between the kiosk and the consumer data device is terminated and processing continues to process block 324. Otherwise, if the consumer desires to download additional media items, then processing returns to process bock 312 to display additional media items for the consumer.

At process block 324, the kiosk completes the payment transaction, for example by totaling the amount of all of the media items downloaded successfully to the consumer data device. Processing continues to process block 326.

At process block 326, the kiosk completes the payment transaction, for example by submitting the payment transaction to the credit card processor. Processing terminates at end block 328.

The systems and processes described above can be performed on or between one or more computing devices 212 as described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system, comprising:
a kiosk;
a network interface;
a sensor displaced in the kiosk configured to identify a consumer;
an interactive display displaced in the kiosk;
a short range communication interface configured to transfer media files on demand to a portable data device of the consumer;
a processor, and a memory and a network interface in data communication with the processor, the memory operable for storage of data including event data corresponding newly released content now available for download, and instructions, the network interface configured for data communication with a communications network,
wherein the processor is configured to
determine the identity of the consumer based at least in part on data from the sensor,
start a communication session with an identified consumer,
determine personalized free or paid content associated with the identified consumer,
retrieve updated event data via the network interface responsive to a link between the kiosk and the portable data device,
determine a user specific subset of downloadable media files from a library of media files to display to the consumer on the interactive display in accordance with a determined identity of the consumer, the user specific subset of downloadable media files including electronic document files, application files and multimedia files,
determine a user prioritized list order of the user specific subset of downloadable media files in accordance with a queue of desired content previously selected by the identified user in a previous communication session and in further in accordance with the updated event data,
display the user specific subset of media files on the interactive display in accordance with the prioritized list order.
receive a user file selection from the subset of media files displayed on the interactive display, and
transfer a selected media file to the portable data device of the consumer in accordance with digital rights management technology.

2. The system of claim 1, wherein the portable data device is selected from the group consisting of a smart phone, a tablet, a cell phone, a laptop, a personal computing device, and a media player.

3. The system of claim 1, wherein the sensor is a camera, and wherein the identity of the consumer is determined at least in part from a captured image.

4. The system of claim 1, wherein the captured image includes one or more portions of a face of the consumer and wherein the identity of the consumer is determined at least in part using facial recognition.

5. The system of claim 4, wherein the captured image includes a code displayed on the portable data device of the consumer, and wherein the identity of the consumer is authenticated using the code.

6. The system of claim 1, wherein the sensor is an audio capture device, and wherein the identity of the consumer is determined at least in part from voice identification of captured audio.

7. The system of claim 1, wherein the sensor communicates with the portable storage device of the consumer to authenticate the consumer.

8. The system of claim 1, wherein the interactive display is a touch screen, and wherein the consumer selects one or more media files to transfer by touching icons associated with one or more media file selections that are displayed on the interactive display.

9. The system of claim 1, wherein the short range communication interface is selected from the group consisting of a TRANSFERJET communication interface, a near field communication interface, a BLUETOOTH interface, and an optical interface.

10. The system of claim 1, wherein the media file selection is made from the group consisting of a movie, a video, a song, an MP3 encoded song, an audio stream, a podcast, written content, a picture, and executable software.

11. The system of claim 1, wherein the embedded controller is further configured to retrieve the selected media from a remote content server over a network.

12. The system of claim 1, wherein the embedded controller is further configured to
receive consumer payment data associated with the consumer, and
process a payment for the selected media with at least one of
a financial institution or
a payment processor.

13. A method, comprising:
identifying, by a sensor displaced in a kiosk, a consumer in proximity to the kiosk;
starting a communication session with an identified customer by linking the kiosk with a portable data device of the identified consumer;
retrieving updated event data from a remote content server;
generating a subset of media files comprised of electronic document files, application files and multimedia files, is based at least in part on an identity of the consumer and the updated event data;
determining personalized free or paid content associated with the identified customer;
determining a list order for the subset of media files prioritized for the consumer in accordance with content previously selected by the consumer in a previous communication session with the kiosk and further in accordance with the event data;
displaying, by a display displaced in the kiosk, indicia corresponding to the personalized content and the subset of media files from an associated media file library available for download by the consumer in accordance with the list order;
receiving, from the consumer, a selection of one or more media files for download; and
transferring, to the portable data device of the consumer, one or more media files corresponding to the selection of media files in accordance with digital rights management technology.

14. The method of claim 14, wherein the sensor is an image capture device, and further comprising:
capturing one or more images of the consumer; and
determining, using facial recognition, the identity of the consumer from the one or more images of the consumer.

15. The method of claim 14, further comprising:
processing a payment for the selection of media with one or more of a financial institution or a payment processor across a network.

16. An on demand media kiosk, comprising:
a display configured to display a customized list of one or more items of downloadable media files available for download from an associated medial library by an identified consumer, the media files comprising electronic document files, application files and multimedia files;
a sensor configured to capture data associated with
the consumer, and
a portable data device of the consumer;
an embedded controller configured to
identify the consumer from the data from the sensor;
commence a communication session with an identified consumer;
determining personalized free or paid content in accordance with a characteristic associated with the identified consumer;
retrieve updated event data from a remote content server;
authenticate the consumer from the data from the sensor;
generating indicia corresponding to the personalized content and a personalized, ordered list of downloadable content for the identified consumer in accordance with an identity of the consumer, content selections made by the identified consumer in an previous communication session, and further in accordance with the event data;
generating a list order of the list of downloadable content personalized for the consumer in accordance with a queue of desired content previously specified by the consumer and the event data;
displaying the personalized content and a list of personalized downloadable content in an order specified by the list order;
determine a selection of media to be downloaded to the portable data device of the consumer based at least in part on interactions of the consumer with the kiosk, an identity of the consumer and the event data,
process a payment by the consumer for the selection of media, and
initiate a transfer of the selection of media files to the portable data device of the consumer in accordance with digital rights management technology; and
a short range communication interface configured to transfer the selection of media files to the portable data device of the consumer when the portable data device is positioned in close proximity to the kiosk.

17. The on demand media kiosk of claim 16, wherein the display is a touch sensitive screen, and wherein the embedded controller is further configured to
determine the selection of media files from the manipulation of icons by the consumer using the touch sensitive screen,
wherein each icon is associated with one or more media file selected from the group consisting of a movie, a video, a song, an MP3 encoded song, an audio stream, a podcast, written content, a picture, and executable software.

18. The on demand media kiosk of claim 16, wherein the sensor is one or more of an audio capture device, an image capture device, a video capture device, a near field communication interface, and a network communications interface, and wherein the short range communication interface is selected from the group consisting of a TRANSFERJET communication interface, a BLUETOOTH interface, and an optical interface.
